(19) United States
(12) Patent Application Publication
(10) Pub. No.: US 2021/0339440 A1
(43) Pub. Date: Nov. 4, 2021

(54) Foaming method by effusing SCF through plastic granules

(71) Applicant: DONGGUAN HAILEX POLYMER MATERIAL SCIENCE AND TECHNOLOGY CO., LTD, DongGuan (CN)

(72) Inventors: Zhenhuan LUO, DongGuan (CN); Ho YIK, DongGuan (CN); Weidong ZHANG, DongGuan (CN)

(73) Assignee: DONGGUAN HAILEX POLYMER MATERIAL SCIENCE AND TECHNOLOGY CO., LTD

(21) Appl. No.: 17/372,407

(22) Filed: Jul. 9, 2021

Related U.S. Application Data
(63) Continuation-in-part of application No. 16/207,190, filed on Dec. 3, 2018.

(51) Int. Cl. B29C 44/34; C08J 9/00; C08J 9/12; C08K 3/26; C08K 5/136; B29C 44/60

(52) U.S. Cl. CPC B29C 44/3453; B29C 44/3461; C08J 9/0066; B29K 2023/083; C08K 3/26; C08K 5/136; B29C 44/60; C08J 9/122

(57) ABSTRACT

A method of microcellular foam molding an article includes feeding plastic granules to a hopper; supplying a supercritical fluid (SCF) to the hopper to effuse through the plastic granules; conveying the effused plastic granules to a buffer tank; and conveying the effused plastic granules in the buffer tank to a mold of an injection molding machine to perform foam molding on the effused plastic granules to produce a foamed article. In a second embodiment, the injection molding machine is replaced by an extrusion press.

### CROSS REFERENCE OF RELATED APPLICATION

This is a continuation-in-part patent application of application Ser. No. 16/207,190, filing date Dec. 3, 2018. The contents of these specifications, including any intervening amendments thereto, are incorporated herein by reference.

### BACKGROUND OF THE PRESENT INVENTION

### Field of Invention

The invention relates to microcellular foam and more particularly to a foaming method by effusing a supercritical fluid (SCF) through plastic granules at a predetermined pressure range and a predetermined temperature range.

### BACKGROUND OF THE INVENTION

### Description of Related Arts

Physical or chemical foaming agents are added to polymeric foaming materials to form bubbles therein. The foaming process comprises the steps of forming gas bubbles, nucleation, and stabilization. Typically, gas under high pressure is dissolved into various polymers, relying on thermodynamic instability phenomena to cause the uniform arrangement of the gas bubbles.

Microcellular foam and their methods of manufacturing has become more standardized and improved upon since late 1970s. Trexel Inc. is often referred to as the industry standard for microcellular foam with their use of MuCell® Molding Technology which is characterized by connecting a device containing a SCF to an injection molding machine (or extrusion press), introducing the SCF into the injection molding machine (or extrusion press) to mix with polymers, and injecting the mixture into a mold. An article is produced after cooling the mold.

However, the time required for the SCF and polymers to mix at the mouth of the injection molding machine is too long, hence failing to supply the mixed polymer continuously in a timely manner for the subsequent molding process for maintaining a continuous production line.

However, the conventional MuCell® Molding Technology has the following disadvantages: greater specific gravity (e.g., more than 0.4), low resilience, poor touch feeling, irregularities on the surface, and being not appropriate for the production of shoes, mats and exercise equipment. Further, using paraffin such as butane, pentane, or hexane or chemical compounds having a lower evaporation temperature as foaming agent is not environment-friendly. Furthermore, conventionally, polyolefin compound or elastomers are foamed externally of a mold prior to placing in the mold. This manufacturing process is time consuming, tedious and not economical.

Still conventionally, foaming internally of a mold has the following disadvantages: springs or the like being liable to damage, breakage and deformation; and the mold being liable to breakage. Thus, the need for improvement still exists.

### SUMMARY OF THE PRESENT INVENTION

It is therefore one object of the invention to provide a method of microcellular foam molding an article, comprising the steps of (1) feeding plastic granules to a hopper; (2) supplying a supercritical fluid (SCF) to the hopper to effuse through the plastic granules; (3) conveying the effused plastic granules to a buffer tank; and (4) conveying the effused plastic granules in the buffer tank to a mold of an injection molding machine to perform foam molding on the effused plastic granules to produce a foamed article.

Preferably, in step (2) the effusion occurs in 7-70 MPa range and 35-140° C. for 0.5-8 hours.

Preferably, in step (2) the SCF is carbon dioxide, water, methane, ethane, methanol, ethanol, ethylene, propylene, acetone, nitrogen, or a combination thereof.

Preferably, the buffer tank is kept at 7-70 Mpa and 0-100° C.

Preferably, the plastic granules are formed of polyolefin compound and in step (4) for making a chemical crosslinking possible, the mold is kept at 140-200° C. and 7-70 Mpa for a foaming time of 60-950 seconds.

Preferably, the polyolefin compound comprises at least one of ethylene-vinyl acetate (EVA), polyolefin elastomer (POE), low-density polyethylene (LOPE), and ethylene propylene diene monomer (EPDM) rubber.

Preferably, there is further provided the sub-step of adding at least one of crosslinking agents, fillers, and chemical additives to the polyolefin compound; and wherein the crosslinking agents comprise at least one of daichlorophenols (DCP) and Bis(tert-butylperoxy isopropyl) benzene (BIPB); the fillers comprise at least one of calcium carbonate, pulvistalci, zinc oxide, and titanium dioxide; and the chemical additives comprise at least one of paraffin and stearic acid.

Preferably, for the polyolefin compound having 100 phr, the crosslinking agents have 0.15 phr-1.2 phr, the fillers have less than 30 phr, and the chemical additives have less than 10 phr.

Preferably, the plastic granules are formed of elastomers and wherein in step (4) for no chemical crosslinking, the mold is kept at 10-50° C. and 7-70 Mpa for a foaming time of 50-120 seconds.

Preferably, the elastomers comprise at least one of thermoplastic polyurethane (TPU), thermoplastic polyester elastomer (TPEE), and thermoplastic elastomer.

It is another object of the invention to provide a method of microcellular foam molding an article, comprising the steps of (A) feeding plastic granules to a hopper; (B) supplying a supercritical fluid (SCF) to the hopper to effuse through the plastic granules; (C) conveying the effused plastic granules to a buffer tank; and (D) conveying the effused plastic granules in the buffer tank to a die of an extrusion press to perform foam molding on the effused plastic granules to produce a foamed article.

According to the present invention, the foregoing and other objects and advantages are attained by a method of microcellular foam molding an article, comprising the steps of:

(a) Feeding plastic granules to a hopper through a first inlet of the hopper;

(b) Supplying SCF to the hopper through a connecting pipe to a second inlet for carrying out effusion between the SCF and the plastic granules inside the hopper;

(c) Conveying effused plastic granules from an outlet of the hopper to an inlet of the buffer tank through a connecting pipe, wherein the buffer tank and the hopper are communicate through the connecting pipe, and the buffer tank has a receiving cavity smaller than a receiving cavity of the hopper;

(d) Allowing the effused plastic granules to store inside the buffer tank while continuously supplying the SCF through the connecting pipe and the hopper;

(e) Conveying the effused plastic granules from the buffer tank to a foam molding device such as an injection molding machine and an extrusion press to perform foam molding on the plastic granules.

The present invention has the following advantageous effects in comparison with the prior art: the formed article is produced in one process with a great reduction of the manufacturing cost. The foamed article has a specific gravity of less than 0.35. The foamed article has many applications including mats, shoes, exercise equipment, toys and packing materials. The foamed article causes no pollution to the environment and has excellent resilience and smooth surfaces. Finally, a continuous supplying of the plastic granules to the injection molding machine (or the extrusion press) is made possible.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 is a flow chart of a foaming method according to a first preferred embodiment of the invention.

FIG. 2 is a flow chart of a foaming method according to a second preferred embodiment of the invention.

FIG. 3 is a schematic diagram of a system for the mold foaming method according to a preferred embodiment of the present invention.

FIG. 4 is a flow chart of a foam molding method according to a preferred embodiment of the present invention.

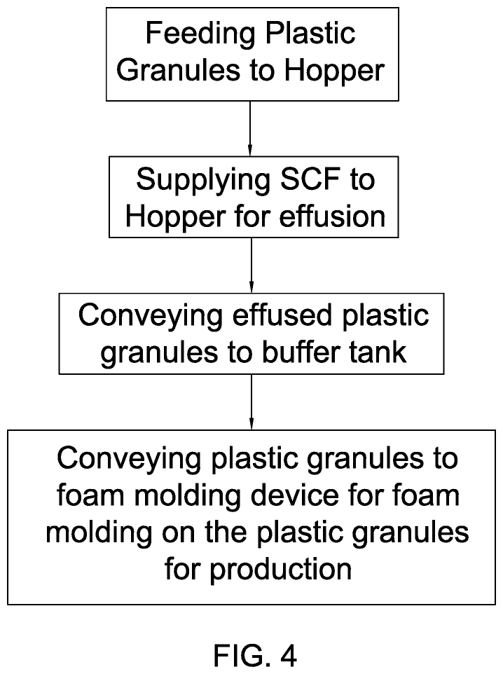

### DETAILED DESCRIPTION OF THE PREFERRED EMBODIMENT

Embodiments of the present invention are described in detail below in connection with the accompanying drawings and embodiments.

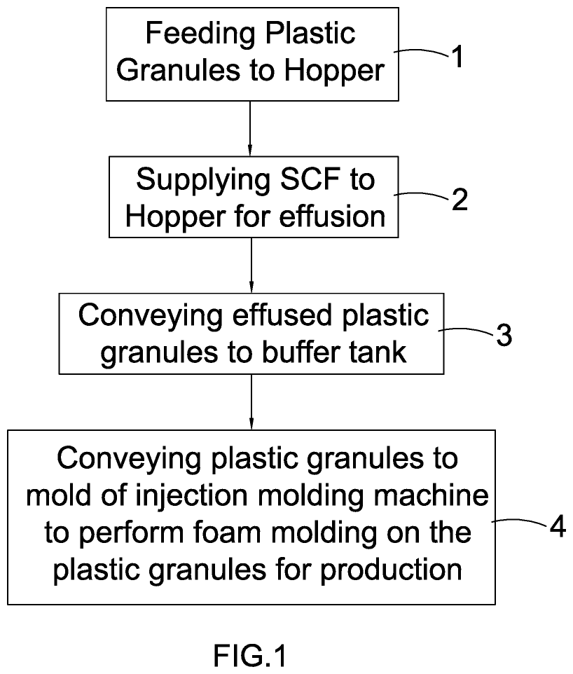

Referring to FIG. 1, a flow chart of a foaming method in accordance with a first preferred embodiment of the invention is illustrated by comprising the following steps as discussed in detail below.

step 1: feeding plastic granules to a hopper;

step 2: supplying an SCF to the hopper to effuse through the plastic granules;

step 3: conveying the effused plastic granules to a buffer tank; and

step 4: conveying the effused plastic granules in the buffer tank to a mold of an injection molding machine to perform foam molding on the effused plastic granules to produce a foamed article.

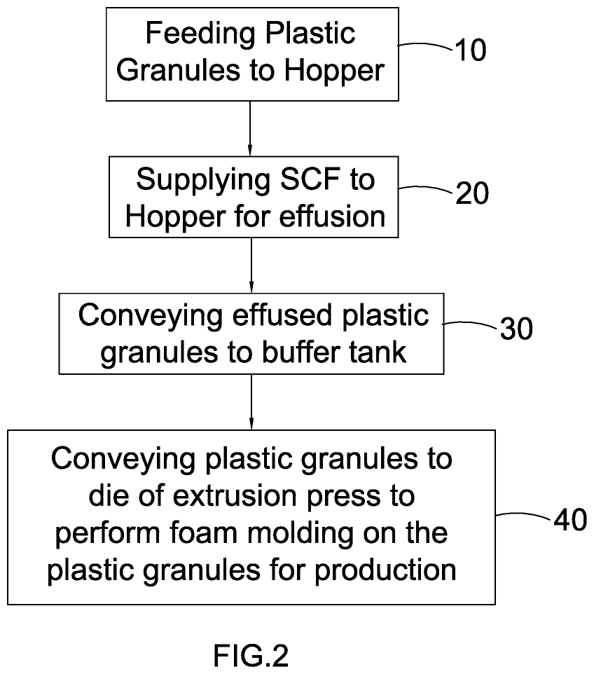

Referring to FIG. 2, a flow chart of a foaming method in accordance with a second preferred embodiment of the invention is illustrated by comprising the following steps as discussed in detail below.

step 10: feeding plastic granules to a hopper;

step 20: supplying an SCF to the hopper to effuse through the plastic granules;

step 30: conveying the effused plastic granules to a buffer tank; and

step 40: conveying the effused plastic granules in the buffer tank to a die of an extrusion press to perform foam molding on the effused plastic granules to produce a foamed article.

Referring to both FIGS. 1 and 2 again, the hopper, the buffer tank, and the injection molding machine (or the extrusion press) are interconnected and are kept at both a predetermined pressure range and a predetermined temperature range. The plastic granules comprise polyolefin compound and elastomers.

During the process (step 1 to 4 or step 10 to 40), high-pressure sealing elements, high-pressure valves, high-pressure joints, high-pressure pipelines, etc. are utilized to connect between the hopper, the buffer tank, the foam molding device and the SCF pipeline to achieve the pressure retaining effect.

The normal temperature and pressure range does not exceed 200° C. and 70 Mpa respectively. Conventional equipment can withstand a temperature and a pressure of 300° C. and 80 Mpa. A pressure holding piping system is used to maintain the pressure of the system. The hopper and the buffer tank are connected therethrough and are maintained at the same pressure level. Injection molding machine or the extrusion press use the structural mechanism of screw threads to achieve pressure holding effect.

The materials that have been mixed with the supercritical fluid in the screw of the injection molding machine is injected into the mold (the mold does not hold pressure), which causes foaming due to pressure drop. Similarly, the material that has been mixed with supercritical fluid in the screw of the injection molding machine will foam due to the pressure drop when it exits the die.

The temperature of different components such as hopper, buffer tank, injection molding machine and the extrusion press are controlled individually.

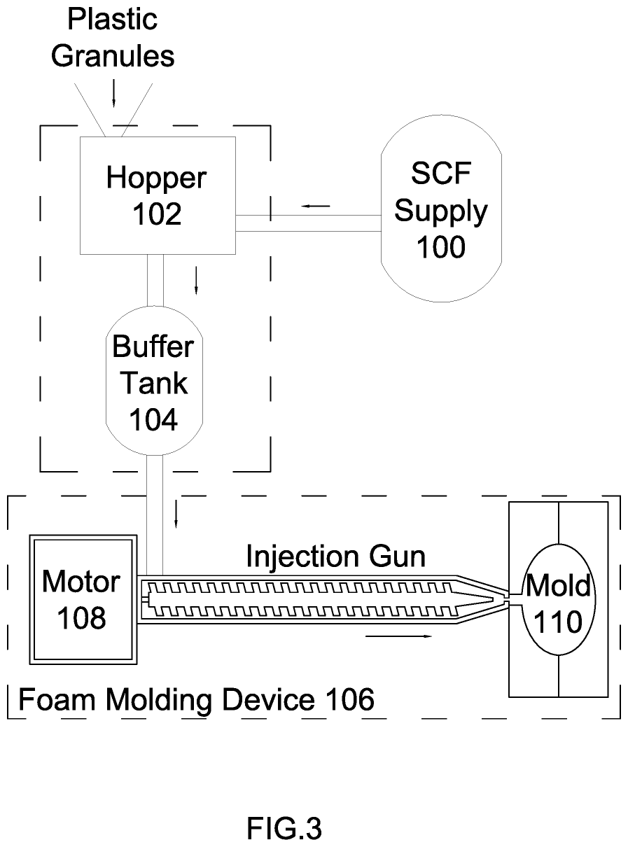

Referring to FIG. 3 of the drawings, a system for the method of microcellular foam molding an article includes a hopper 102 having an inlet for receiving plastic granules, a SCF supply 100 connecting to the hopper 102 for supply SCF to the hopper, a buffer tank 104 below the hopper 102, a foam molding device 106 (such as an injection molding machine or an extrusion press) driven through a motor 108 and positioned below the buffer tank 104, and a mold 110 connecting to the foam molding device 106.

The hopper 102 is installed at a higher position than the buffer tank 104 while the buffer tank 104 is installed at a higher position than the injection molding machine or the extrusion press 106. Thus, by means of gravity, the plastic granules are guided to move from the hopper 102 to the buffer tank 104, and then from the buffer tank 104 to the foam molding device 106 such as injection molding machine or the extrusion press. Then, the injection molding machine or extruding press uses its screw to feed and melt and mix the materials that have been effused by SCF.

The buffer tank 104 has a smaller size than the hopper 102. The buffer tank 104 has a top opening connecting to the hopper 102 and a bottom opening connecting to the foam molding device 106. The buffer tank 104 communicates with the hopper 102 though the top opening and the connecting pipe continuously so that the buffer tank 104 is filled with SCF continuously. In other words, the buffer tank 104 is supplied with the SCF through the connecting hopper 102 such that the plastic granules can be stored inside the buffer tank 104 and ready for use when needed. Since the buffer tank 104 has a relatively smaller size when compared to the hopper 102, the effusion is more thorough inside the buffer tank 104 while it is easier to eject the plastic granules from the buffer tank 104 to the foam molding device. In other words, the buffer tank 104 can provide the SCF effused plastic granules for subsequent processing such as injection molding or extrusion pressing. As the time needed for effusion is excessive long, the provision of the buffer tank 104 can shorten the foam molding time dramatically and smooth the whole manufacturing process.

In the system, high-pressure sealing elements, high-pressure valves, high-pressure joints, high-pressure pipelines, etc. are utilized to connect between the hopper, the buffer tank, the foam molding device and the SCF pipeline to achieve the pressure control of different elements. The hopper 102 and the buffer tank 104 are interconnected and their receiving cavities communicates with each other, so the pressure of the hopper 102 and the buffer tank 104 can be maintained at the same level and the SCF can be supplied to the buffer tank 104 through the hopper 102.

It is also possible that the buffer tank can have an additional opening for connecting to the SCF and under this setting, the pressure of the buffer tank can be adjusted independently to have a different pressure from the hopper.

The polyolefin compound comprises at least one of ethylene-vinyl acetate (EVA), polyolefin elastomer (POE), low-density polyethylene (LOPE), ethylene propylene diene monomer (EPDM) rubber. In a first example, EVA is taken as the polyolefin having a 5%-40% mole. In a second example, a combination of EVA and POE having a composition ratio of 100/0.1-0.1/100 is taken as the polyolefin. In a third example, a combination of EVA, POE, and ethylene propylene diene monomer (EPDM) rubber having a composition ratio of 100/0.1/0.1-0.1/100/20.

At least one of crosslinking agent, filler, and chemical additive can be added to the polyolefin compound. The crosslinking agent reacts with molecules of the polyolefin compound to form bridges between polymer molecular links and in turn form an insolvable substance having a three-dimensional structure. The filler can improve performance or reduce production costs. The chemical additive can increase flowability. For the polyolefin compound having 100 parts per hundred rubber (phr), the crosslinking agent has 0.15 phr-1.1 phr or preferably 0.25 phr-1.0 phr, the filler has less than 30 phr, and the chemical additive has less than 10 phr.

The crosslinking agent comprises at least one of daichlorophenols (DCP) and Bis(tert-butylperoxy isopropyl) benzene (BIPB).

Filler comprises at least one of calcium carbonate, pulvistalci, zinc oxide and titanium dioxide.

Chemical additive comprises at least one of paraffin and stearic acid.

Preferably, the elastomers comprise at least one of thermoplastic polyurethane (TPU), thermoplastic polyester elastomer (TPEE), and Pebax® thermoplastic elastomer.

Examples of the SCF are carbon dioxide, water, methane, ethane, methanol, ethanol, ethylene, propylene, acetone, nitrogen, and a combination thereof.

Preferably, SCF with a temperature and a pressure not exceeding 300° C. and 80 Mpa are selected. SCF with a temperature and a pressure not exceeding 300° C. and 80 Mpa includes carbon dioxide, methane, ethane, methanol, ethanol, ethylene, propylene, acetone and nitrogen.

Preferably, carbon dioxide with a critical temperature of 31.10° C. and a critical pressure of 72.9 atm (7.39 MPa), or nitrogen gas with a critical temperature of −147° C. (minus 147 degrees) and a critical pressure is 33.5 atm (3.39 MPa) is used.

In general, the effusion occurs in a pressure range of 7-70 MPa and a temperature range of 35-140° C. for 0.5-8 hours. When carbon dioxide or nitrogen is used s the SCF, the effusion occurs in a pressure range of 20-30 MPa and a temperature range of 70-200° C. for 1-5 hours.

Preferably, for polyolefin compound, the effusion occurs in a pressure range of 7-70 MPa and a temperature range of 30-80° C. for 0.5-8 hours; and preferably, for elastomers the effusion occurs in a pressure range of 7-70 MPa and a temperature range of 50-130° C. for 1-8 hours.

In the plastic granules effused by SCF, the SCF has a weight percentage of 1-10% (i.e., 1-10 w %).

The buffer tank is kept at a pressure range of 7-70 Mpa and a temperature range of 0-100° C. Preferably, for polyolefin compound, the buffer tank is kept at a pressure range of 7-70 Mpa and a temperature range of 0-80° C.; and preferably, for elastomers, the buffer tank is kept at a pressure range of 7-70 Mpa and a temperature range of 0-100° C.

The buffer tank is used to temporarily store the effused plastic granules for providing a continuous supply of the effused plastic granules.

Compared to the conventional process, the SCF is supplied at the injection molding machine (or the extrusion press) and an excessive long period of time is required for effusing the plastic granules at the injection molding machine (or the extrusion press), and in turn the continuous supply of effused plastic granules is interrupted, and a continuous supply of effused plastic granules is prevented from supplying to the injection molding machine (or the extrusion press) for production. The method of the present invention is advantageous in that it allows a continuous supplying of the effused plastic granules to the injection molding machine (or the extrusion press) possible.

In other words, the buffer tank stores the effused plastic granules which is capable of supporting a continuous subsequent mass production process (injection molding or extrusion pressing).

For the plastic granules of polyolefin compound, a chemical crosslinking occurs at the injection molding machine with the mold kept at a predetermined pressure range and a predetermined temperature range.

For the plastic granules of elastomers, no crosslinking occurs. The effused plastic granules are injected into a mold of the injection molding machine.

Preferably, for making the crosslinking possible, the mold is kept at a temperature range of 140-200° C. and a pressure range of 7-70 Mpa for a foaming time (or crosslinking time) of 60-950 seconds.

Preferably, for no crosslinking, the mold is kept at a temperature range of 10-50° C. and a pressure range of 7-70 Mpa for a foaming time of 50-120 seconds.

In the step 40 of conveying the plastic granules in the buffer tank to a die of an extrusion press to perform foam molding on the plastic granules in which the effused plastic granules are kept at a temperature range of 140-200° C. and a pressure range of 7-70 Mpa.

The foamed article produced by the invention contains billions of tiny bubbles having a size from 0.1 to 3 micrometers and the bubbles have a specific gravity of 0.03-0.30 g/cm³.

In one experiment, the foamed article undergoes three fatigue tests repeatedly with a load of 10-80 kg. It is found that its stability is increased by 30% in comparison with the article made by a conventional EVA foaming material.

The foamed article has a bouncing capability of at least 50% by testing with a ball free falling test based on ASTM 02632. Also, the bouncing capability can be maintained for 10 to 60 days in comparison with the article made by a conventional EVA foaming material. This 10 to 60 days period is increased by 30% in comparison with that of the article made by a conventional EVA foaming material.

The foamed article has many applications including mats, shoes, exercise equipment, toys and packing materials. For a shoe as the produced foamed article of the invention, billions of tiny bubbles of the shoe have a size from 0.1 to 3 micrometers and the bubbles have a specific gravity of 0.05-0.30 g/cm3; and the shoe has a bouncing capability of at least 50% by testing with a ball free falling test based on ASTM 02632. For mat as the produced foamed article of the invention, billions of tiny bubbles of the mat have a size from 0.1 to 3 micrometers and the bubbles have a specific gravity of 0.03-0.20 g/cm3; and the shoe has a bouncing capability of at least 50% by testing with a ball free falling test based on ASTM 02632.

The foaming materials have advantages including low specific gravity, no pollution to the environment, excellent resilience, and smooth surface. The formed article is produced in one process with a great reduction of the manufacturing cost. The step of providing a buffer tank to temporarily store the effused plastic granules makes a continuous supplying of the plastic granules to the injection molding machine (or the extrusion press) possible. Finally, it not only saves labor but also saves energy.

Embodiment 1: EVA (e.g., EVA7470 produced by Formosa Plastics Corporation) of 100 phr in which ethenyl acetate in the EVA has 26% mole, calcium carbonate of 1 phr, paraffin of 0.5 phr, and DCP of 0.5 phr are added to a buffer tank to mix for 12 minutes under conditions of 50° C. and 0.7 Mpa. Then a SCF (e.g., carbon dioxide (CO2)) is effused through the mixture for 2 hours under conditions of 50° C. and 40 Mpa. Plastic granules effused by the SCF are obtained. the effused plastic granules have a foaming ratio of less than 1.5 and the SCF has 10 w %. The effused plastic granules are temporarily stored in the buffer tank. In a foam molding step, the effused plastic granules are conveyed from the buffer tank to a mold of an injection molding machine to perform foam molding by crosslinking the plastic granules for 60-950 seconds under conditions of 140-200° C., 7-70 Mpa. As a result, a foamed article having a smooth surface is produced.

The physical properties of the resulting foamed article are illustrated in Table 1: Physical Property Test Report as follows:

TABLE 1
Physical Property Test Report

| | Test | | | |
|---|---|---|---|---|
| Test Item | condition | Unit | 18H53 | Test method |
| Durometer | 3~5 s | Type C | 35 | SATRA TM 205-16 |
| Density | | g/cm³ | 0.1621 | SATRA TM 134-1998 |
| Compression | 50° × 6 h | % | 62.64 | ASTM D395B-2003 |
| Set | | | | |
| Shrinkage | 70° × 40 min | % | −2.11 | SATRA TM70-2001 |
| Resilience | | % | 57 | DIN 53512-2000 |
| Tensile | | kg/cm² | 18.19 | ASTM D-412 |
| Elongation | | % | 492 | ASTM D-412 |
| Die C Tear | | kg/cm | 14.33 | ASTM D-624 |
| Split Tear | | kg/cm | 1.83 | SATRA TM65-2015 |

Embodiment 2: EVA is replaced by a compound of EVA (60%)/POE (40%) in which ethenyl acetate in the EVA has 26% mole, and POE having a serial number 8150 is produced by Dows Inc. Other manufacturing steps are the same as that of embodiment 1. The produced article is a foamed article.

The produced foamed article has a specific gravity of 0.13, an average diameter of the bubbles in the produced foamed article is 0.5-2.0 mm, and the bouncing capability of the produced foamed article is 60%.

The physical properties of the resulting foamed article are illustrated in Table 2: Physical Property Test Report as follows:

TABLE 2
Physical Property Test Report

| | Test | | | |
|---|---|---|---|---|
| Test Item | condition | Unit | 18H60 | Test method |
| Durometer | 3~5 s | Type C | 39 | SATRA TM 205-16 |
| Density | | g/cm³ | 0.1391 | SATRA TM 134-1998 |
| Compression | 50° × 6 h | % | 71.95 | ASTM D395B-2003 |
| Set | | | | |
| Shrinkage | 70° × 40 min | % | −3.58 | SATRA TM70-2001 |
| Resilience | | % | 62 | DIN 53512-2000 |
| Tensile | | kg/cm² | 17.11 | ASTM D-412 |
| Elongation | | % | 387 | ASTM D-412 |
| Die C Tear | | kg/cm | 13.24 | ASTM D-624 |
| Split Tear | | kg/cm | 2.85 | SATRA TM65-2015 |

Embodiment 3: EVA is replaced by a compound of EVA (60%)/POE (40%) in which ethenyl acetate in the EVA has 26% mole, and POE having a serial number 8150 is produced by Dows Inc. Further, CO₂ is replaced by nitrogen as SCF. Other manufacturing steps are the same as that of embodiment 1. The produced article is a foamed article.

The produced foamed article has a specific gravity of 0.15, an average diameter of the bubbles in the produced foamed article is 0.5-2.5 mm, and the bouncing capability of the produced foamed article is 58%.

The physical properties of the resulting foamed article are illustrated in Table 3: Physical Property Test Report as follows:

TABLE 3
Physical Property Test Report

| | Test | | | |
|---|---|---|---|---|
| Test Item | condition | Unit | 18H67 | Test method |
| Durometer | 3~5 s | Type C | 42 | SATRA TM 205-16 |
| Density | | g/cm³ | 0.1572 | SATRA TM 134-1998 |
| Compression | 50° × 6 h | % | 66.83 | ASTM D395B-2003 |
| Set | | | | |
| Shrinkage | 70° × 40 min | % | −2.38 | SATRA TM70-2001 |
| Resilience | | % | 59 | DIN 53512-2000 |
| Tensile | | kg/cm² | 18.92 | ASTM D-412 |
| Elongation | | % | 352 | ASTM D-412 |
| Die C Tear | | kg/cm | 15.23 | ASTM D-624 |
| Split Tear | | kg/cm | 2.94 | SATRA TM65-2015 |

Embodiment 4: EVA is replaced by a compound of TPU having a serial number 85AU10 produced by Sistron Inc. and the steps of mixing and crosslinking are omitted. Other manufacturing steps are the same as that of embodiment 1. The produced article is a foamed article.

The produced foamed article has a specific gravity of 0.28, an average diameter of the bubbles in the produced foamed article is 0.5-1.5 mm, and the bouncing capability of the produced foamed article is 55%.

The physical properties of the resulting foamed article are illustrated in Table 4: Physical Property Test Report as follows:

TABLE 4
Physical Property Test Report

| | Test | | | |
|---|---|---|---|---|
| Test Item | condition | Unit | 18H71 | Test method |
| Durometer | 3~5 s | Type C | 57 | |
| Density | | g/cm³ | 0.2837 | SATRA TM 134-1998 |
| Compression | 50° × 6 h | % | 34.52 | ASTM D395B-2003 |
| Set | | | | |
| Shrinkage | 70° × 40 min | % | −0.15 | SATRA TM70-2001 |
| Resilience | | % | 57 | DIN 53512-2000 |
| Tensile | | kg/cm² | 28.32 | ASTM D-412 |
| Elongation | | % | 409 | ASTM D-412 |
| Die C Tear | | kg/cm | 25.43 | ASTM D-624 |
| Split Tear | | kg/cm | 4.02 | SATRA TM65-2015 |

Exemplary example 1: The conventional MuCell® Molding Technology is used in which a SCF foaming device is used to produce TPU foaming articles. Hopper is heated to 210° C. and the mold is heated to 30° C. SCF (e.g., nitrogen) is introduced to the injection molding machine to mix with molten TPU. The molten TPU mixture is injected into a mold cavity to form. The SCF reacts with the molten TPU mixture to form bubbles in the mold cavity.

The produced foamed article has the same size as that of the mold cavity but has irregularities on the surface. The produced foamed article has a specific gravity of 0.4-0.55, an average diameter of the bubbles in the produced foamed article is 0.8-2.0 mm, and the bouncing capability of the produced foamed article is 50%.

Exemplary example 2: except the prefoaming ratio greater than 1.6 after introducing the SCF, other manufacturing steps are the same as that of embodiment 1. The produced article is a foamed article.

The produced foamed article has a specific gravity of 0.22, an average diameter of the bubbles in the produced foamed article is 0.5-1.7 mm, and the bouncing capability of the produced foamed article is 50%.

Exemplary example 3: except the crosslinking agent DCP in the embodiment 1 has 1.25 phr, other manufacturing steps are the same as that of embodiment 1.

The produced article is a foamed article. The produced foamed article has a specific gravity of 0.32, an average diameter of the bubbles in the produced foamed article is 0.2-0.8 mm, and the bouncing capability of the produced foamed article is 40%.

Exemplary example 4: except the crosslinking agent DCP in the embodiment 1 has 0.12 phr, other manufacturing steps are the same as that of embodiment 1. The produced article is a foamed article.

The produced foamed article has a specific gravity of 0.42, an average diameter of the bubbles in the produced foamed article is 0.2-0.6 mm, and the bouncing capability of the produced foamed article is 35%.

Exemplary example 5: except the crosslinking agent DCP in the embodiment 2 has 0.12 phr, other manufacturing steps are the same as that of embodiment 2.

The produced article is a foamed article. The produced foamed article has a specific gravity of 0.35, an average diameter of the bubbles in the produced foamed article is 0.1-0.8 mm, and the bouncing capability of the produced foamed article is 42%.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of microcellular foam molding an article, comprising the steps of:
(1) feeding plastic granules to a receiving cavity of a hopper;
(2) supplying a supercritical fluid (SCF) to the hopper to effuse through the plastic granules inside the receiving cavity of the hopper, wherein a critical temperature and a pressure of the SCF are not exceeding 300° C. and 80 Mpa respectively;
(3) conveying the effused plastic granules to a buffer tank from the hopper, wherein the effused plastic granules inside the buffer tank are ready for subsequent use; and
(4) controlling and conveying the effused plastic granules in the buffer tank to a mold of an injection molding machine to perform a foam molding on the effused plastic granules with a foaming time less than 16 minutes to produce a foamed article, thereby the foam molding is capable of being carried out continuously for mass production.

2. The method of claim 1, wherein in step (2) the effusion occurs in 7-70 MPa range and 35-140° C. for 0.5-8 hours.

3. The method of claim 2, wherein in step (2) the SCF is carbon dioxide, methane, ethane, ethylene, propylene, nitrogen, or a combination thereof.

4. The method of claim 1, wherein the buffer tank is kept at 7-70 Mpa and 0-100° C., wherein the buffer tank and the hopper are channel through, a pressure of the buffer tank is equal to a pressure the hopper, and the buffer tank is supplied with SCF continuously through connecting to the hopper.

5. The method of claim 1, wherein the plastic granules are formed of polyolefin compound and wherein in step (4) for making a chemical crosslinking possible, the mold is kept at 140-200° C. and 7-70 Mpa for a foaming time of 60-950 seconds.

6. The method of claim 3, wherein the plastic granules are formed of polyolefin compound and wherein in step (4) for making a chemical crosslinking possible, the mold is kept at 140-200° C. and 7-70 Mpa for a foaming time of 60-950 seconds.

7. The method of claim 4, wherein the plastic granules are formed of polyolefin compound and wherein in step (4) for making a chemical crosslinking possible, the mold is kept at 140-200° C. and 7-70 Mpa for a foaming time of 60-950 seconds.

8. The method of claim 5, wherein the polyolefin compound comprises at least one of ethylene-vinyl acetate (EVA), polyolefin elastomer (POE), low-density polyethylene (LOPE), and ethylene propylene diene monomer (EPDM) rubber.

9. The method of claim 6, wherein the polyolefin compound comprises at least one of ethylene-vinyl acetate (EVA), polyolefin elastomer (POE), low-density polyethylene (LOPE), and ethylene propylene diene monomer (EPDM) rubber.

10. The method of claim 7, wherein the polyolefin compound comprises at least one of ethylene-vinyl acetate (EVA), polyolefin elastomer (POE), low-density polyethylene (LOPE), and ethylene propylene diene monomer (EPDM) rubber.

11. The method of claim 8, further comprising the sub-step of adding at least one of crosslinking agents, fillers, and chemical additives to the polyolefin compound; and wherein the crosslinking agents comprise at least one of daichlorophenols (DCP) and Bis(tert-butylperoxy isopropyl) benzene (BIPB); the fillers comprise at least one of calcium carbonate, pulvistalci, zinc oxide, and titanium dioxide; and the chemical additives comprise at least one of paraffin and stearic acid.

12. The method of claim 9, further comprising the sub-step of adding at least one of crosslinking agents, fillers, and chemical additives to the polyolefin compound; and wherein the crosslinking agents comprise at least one of daichlorophenols (DCP) and Bis(tert-butylperoxy isopropyl) benzene (BIPB); the fillers comprise at least one of calcium carbonate, pulvistalci, zinc oxide, and titanium dioxide; and the chemical additives comprise at least one of paraffin and stearic acid.

13. The method of claim 10, further comprising the sub-step of adding at least one of crosslinking agents, fillers, and chemical additives to the polyolefin compound; and wherein the crosslinking agents comprise at least one of daichlorophenols (DCP) and Bis(tert-butylperoxy isopropyl) benzene (BIPB); the fillers comprise at least one of calcium carbonate, pulvistalci, zinc oxide, and titanium dioxide; and the chemical additives comprise at least one of paraffin and stearic acid.

14. The method of claim 11, wherein for the polyolefin compound having 100 phr, the crosslinking agents have 0.15 phr-1.2 phr, the fillers have less than 30 phr, and the chemical additives have less than 10 phr.

15. The method of claim 12, wherein for the polyolefin compound having 100 phr, the crosslinking agents have 0.15 phr-1.2 phr, the fillers have less than 30 phr, and the chemical additives have less than 10 phr.

16. The method of claim 13, wherein for the polyolefin compound having 100 phr, the crosslinking agents have 0.15 phr-1.2 phr, the fillers have less than 30 phr, and the chemical additives have less than 10 phr.

17. The method of claim 1, wherein the plastic granules are formed of elastomers and wherein in step (4) for no chemical crosslinking, the mold is kept at 10-50° C. and 7-70 Mpa for a foaming time of 50-120 seconds.

18. The method of claim 3, wherein the plastic granules are formed of elastomers and wherein in step (4) for no chemical crosslinking, the mold is kept at 10-50° C. and 7-70 Mpa for a foaming time of 50-120 seconds.

19. The method of claim 18, wherein the elastomers comprise at least one of thermoplastic polyurethane (TPU), thermoplastic polyester elastomer (TPEE), and thermoplastic elastomer.

20. The method of claim 19, wherein in step (2) the effusion occurs in 7-70 MPa rang and 35-140° C. for 0.5-8 hours.
